(19) United States
(12) Patent Application Publication
(10) Pub. No.: US 2005/0046108 A1
(43) Pub. Date: Mar. 3, 2005

(54) Game apparatus and method

(75) Inventors: Dragan Filipovic, Morton Grove, IL (US); James MacNamara, Wheeling, IL (US); Brian Sobecks, Glenview, IL (US); Jeffrey Gibb, Boonton, NJ (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/650,462

(22) Filed: Aug. 28, 2003

(51) Int. Cl. A63F 13/00

(52) U.S. Cl. 273/237

(57) ABSTRACT

A game board apparatus (10) includes a channel (12) that contains and guides a game position marker (11) to a game position marker station as selected by a game player. An access channel (28) serves to provide convenient access to both the marker (11) and the channel (12) to facilitate such selected movement and positioning. Pressure exerted on the apparatus in the vicinity of the game position marker (11) will cause the game position marker (11) to close an electric circuit that includes two opposing electrodes (13 and 15). Completion of this circuit in turn can serve to energize a corresponding alert (such as a visual cue, an auditory cue, and the like). In a preferred embodiment, two such game boards are coupled one to the other to facilitate game play.

### TECHNICAL FIELD

This invention relates generally to games.

### BACKGROUND

Games of various kinds have long been known and enjoyed. Some games tend to reward the more skillful player and some tend to be based more upon chance. In either case, some games are characterized by numerous and/or relatively complicated rules and other conditions regarding play while other games are relatively simple in this regard. Traditional games often require mechanical movement and/or physical manipulation of one or more physical attributes while many more modern games feature the use of electricity to either compliment and/or augment such physical play or to replace or otherwise substitute for such physical interfacing.

While some games have proven to consistently provide a compelling game play experience for many players over the years, many game players nevertheless tend to welcome a new game that offers a new experience. In addition, many existing games are sufficiently complex as to render it difficult to attain a successful and rewarding game play experience for particularly young players, such as children.

Many products suitable for use or consumption by children are marketed with an accompanying promotional item or concept. In some cases, such promotional items have comprised a simple game or puzzle such as a maze. In general, such games or puzzles have tended towards being purely physical/mechanical rather than being electrically facilitated. This preference is perhaps driven in part by the need to minimize the cost of such promotional items to thereby maintain a reasonable offering price and profit margin of the corresponding product. Notwithstanding this historical predilection, modern consumers (including, perhaps especially, young consumers) have a clearly evinced preference for electronic and/or electrically facilitated games. Again, likely due to the challenges of providing a cost effect game platform simultaneously with providing a game having a suitable level of game play for young children, game-based promotional offerings have nevertheless tended towards purely mechanical and physical game-playing platforms.

### BRIEF DESCRIPTION OF THE DRAWINGS

The above needs are at least partially met through provision of the game apparatus and method described in the following detailed description, particularly when studied in conjunction with the drawings, wherein:

FIG. 1 comprises a schematic view as configured in accordance with an embodiment of the invention;

FIG. 2 comprises an exploded perspective view as configured in accordance with an embodiment of the invention;

FIG. 3 comprises a top plan view as configured in accordance with an embodiment of the invention;

FIG. 4 comprises a bottom plan view as configured in accordance with an embodiment of the invention;

FIG. 5 comprises a detail bottom plan view as configured in accordance with an embodiment of the invention;

FIG. 6 comprises a detail bottom plan view as configured in accordance with an embodiment of the invention;

FIG. 7 comprises a side elevational view as configured in accordance with an embodiment of the invention;

FIG. 8 comprises a perspective view as configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a first substrate has a game position marker channel formed therein of a width at least large enough to accommodate a game position marker. A second substrate is disposed proximal to the first substrate and includes an access channel disposed therethrough. The access channel has a width that is, at least in part, narrower than the game position marker, such that the game position marker is retained within the game position marker channel, at least in part, by the second substrate. So configured, a narrow object can be inserted through the access channel and used to move the game position marker to different game positions within the game position marker channel.

In a preferred embodiment, this structure comprises an hermaphroditic guessing game apparatus where opposing players attempt to guess a present location of the game position markers as positioned by one another. In particular, two such structures can be positioned proximal to one another and cooperate in a manner that facilitates game play.

In a preferred embodiment, inexpensive materials, such as paperboard and/or plastic film, can be used for such substrates. If desired, electrically conductive materials (forming, for example, a plurality of electrodes that characterize various potential game position marker stations) can be utilized to facilitate game play through the closure of an electric circuit that coincides with a successful guess regarding a present location of the game position marker. This circuit can include various alert mechanisms, including visual, auditory, haptic, and/or such other sensory stimuli as may be desired. Though such an apparatus can be realized at relatively low cost, the resultant game will nevertheless offering an entertaining game play experience.

These teachings further support the fabrication of game apparatus in various form factors, including many that are suitable for use in marketing promotions of various kinds. For example, such a game apparatus can be including inside the packaging for a given product or can even be fabricated as a part of the packaging itself.

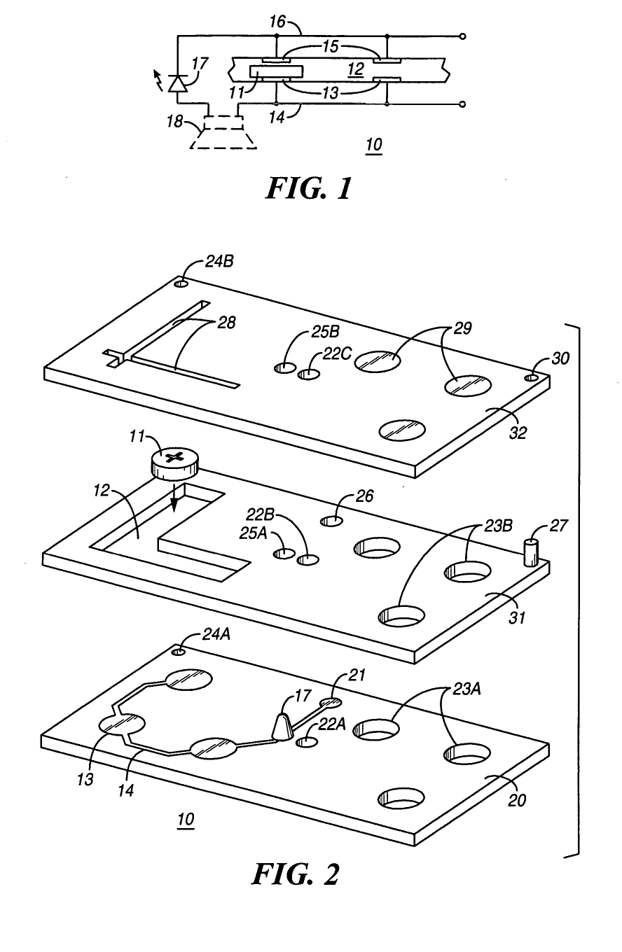

Referring now to FIG. 1, a first illustrative embodiment will be described. Viewed schematically, the game apparatus 10 includes a game position marker 11 that, in a preferred embodiment, is comprised at least in part of electrically conductive material and is substantially disc-shaped (other shapes can be utilized, but as will become more apparent below, a disc shape aids in facilitating relatively convenient movement of the game position marker through a corresponding game position marker channel). In this particular embodiment, the game position marker 11 comprises a battery such as a hearing aid battery or other battery of similar form factor and size. A game position marker channel 12 encapsulates the game position marker 11. This game position marker channel 12 has cross-sectional dimensions at least large enough to accommodate the game position marker 11. Preferably these dimensions will be relatively close to the dimensions of the game position marker 11 with respect to at least one axis of consideration (such as, for example, width) so that the game position marker 11 does not move too freely within the game position marker channel 12 but can still nevertheless be moved with relative ease through the game position marker channel 12 when a game player desires to effect such movement.

A plurality of opposing electrodes 13 and 15 are disposed at various locations along the game position marker channel 12. In this embodiment, the first set of electrodes 13 are electrically inter-coupled via a first conductor 14 and the second set of electrodes 15 are similarly electrically inter-coupled via a second conductor 15. In this schematic representation, only two such opposing pairs of electrodes are depicted. This number can be increased to accommodate as many potential game position marker stations as may be desired and/or as may be appropriate to a given game.

The inter-coupling conductors 14 and 16 electrically couple to one via at least one alert mechanism. In a preferred embodiment, this alert mechanism includes a visual cue, such as but not limited to a light source such as a light emitting diode 17 (other visual cues are possible, either in addition to or in lieu of such an light emitting diode 17 and may be selected and utilized as commensurate with the design constraints and requirements of a given application). So configured, the light source will illuminate when a game player successfully guesses the location of the game position marker 11 by causing an opposing pair of electrodes 13 and 15 to simultaneously come into contact with the game position marker 11. If desired, auditory cues that comprise one or more audible sounds can be provided as well, such as through inclusion of an audio signal source 18. Such an auditory cue can be in addition or in lieu of a visual cue. In similar fashion, other sensory cues can be cumulatively provided and/or used in isolation, including haptic cues (as imparted, for example, through vibration), olfactory cues (as imparted, for example, by release of a pre-stored aroma), and so forth.

So configured, a first game player can move the game position marker 11 to one of a plurality of candidate game position marker stations and a second game player can then guess as to the present location of the game position marker 11. Such guesses are acted upon by physically causing the electrodes 13 and 15 that correspond to a selected game position marker station to be brought into simultaneous physical contact with the game position marker. When present between the selected electrodes 13 and 15, the game position marker 11 will complete the circuit (and, in this embodiment, provide the enabling voltage potential and current flow) and facilitate activation of the alert cue or cues of choice. These teachings can be implemented in relatively cost effective ways. For example, as will be shown below, relatively inexpensive materials can be utilized and furthermore such a circuit can be realized, if desired, sans use of integrated circuits.

Referring now to FIG. 2, additional illustrative details regarding such an embodiment will be presented. A first substrate is comprised of an electrically non-conductive material such as FR-4 or, more preferably, thin plastic sheeting or laminate, paper, or paperboard material (the latter materials being preferred with respect to their relatively low cost). The game position marker stations each include at least one electrode 13, which electrodes 13 are electrically coupled by an inter-coupling conductor 14. (In this embodiment, only three such electrodes 13 are illustrated for the sake of simplicity and clarity, with it being understood that a more preferred approach would likely include provision of an increased number of such electrodes to thereby increase the number of potential game position marker stations.) In this embodiment, both the electrodes 13 and the inter-coupling conductor 14 are formed through appropriate deposition of conductive material such as copper or a conductive ink as well understood in the art (of course, if desired, such electrodes and conductors could also be formed by removing selected portions of a layer of previously applied conductive material as is also well understood in the art).

In this embodiment, the inter-coupling conductor 14 further includes a portion that couples to a pad 21 that serves, as described below in more detail, to electrically couple this portion of the circuit to another portion on another layer of the apparatus 10. It can also be seen that one or more of the alert mechanisms can be supported on or in this first substrate 20 as well. To illustrate, in this embodiment, a light emitting diode 17 is disposed on the first substrate 20 and is coupled in series with the inter-coupling conductor 14.

This first substrate 20 also has a number of holes disposed therethrough. A first hole 22A is positioned relatively proximal to the light emitting diode 17 and serves, as shown below, to receive the light emitting diode of a counterpart game board and/or to direct the light being emitted by such a light emitting diode towards a corresponding game player. Another set of holes 23A serve to identify game position marker stations of a counterpart game apparatus 10 when two such apparatus 10 are joined together as described below. In a preferred approach, such holes 23A are of sufficient size to accommodate a selection tool, such as a game player's finger or other provided mechanism. A last hole 24A serves as a keyhole to permit alignment and proper registration of the apparatus 10 when combined with another such apparatus 10, again as described in more detail below.

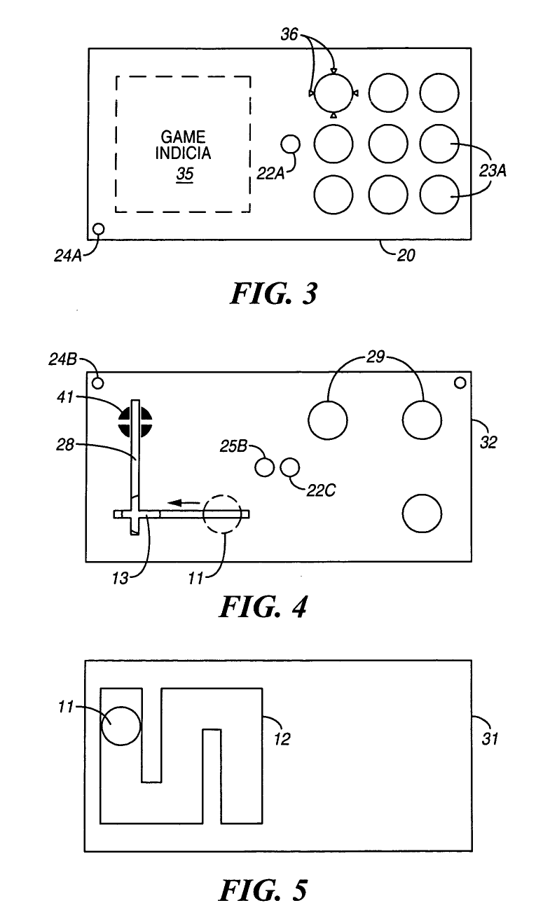

As will become clear in a moment, the above-described surface of the first substrate 20 comprises an interior surface. The opposing side of the first substrate 20 comprises, in this embodiment, an exterior surface. With momentary reference to FIG. 3, this exterior surface of the first substrate 20 can include a portion where text and/or graphics comprising, for example, game indicia 35 (such as the name of the game, game play instructions, and the like) are displayed. Such indicia can also be displayed in other locations on this exterior surface and can further include, if desired, identifying indicia 36 that corresponds to candidate game positions for the game position marker of an opposing player's apparatus 10. Such identifying indicia 36 are preferably disposed proximal to the holes 23A provided therefor and can be any graphic, textual, and/or topographic element that can serve such a purpose (four inwardly directed arrowheads are depicted in conjunction with a single such opening 23A in FIG. 3 to exemplify this teaching).

Returning again to FIG. 2, a second substrate 31 is comprised of any suitable non-conductive material (and is preferably comprised of, for example, paperboard) and is further of sufficient thickness to receive the game position marker 11 within a game position marker channel 12 as is formed therein. This game position marker channel 12 will preferably track and otherwise permit game position marker 11 access to each of the station electrodes 13 on the first substrate 20. In this embodiment, with only three such electrodes 13 being depicted for the sake of simplicity and clarity, an L-shaped game position marker channel 12 will suffice in this regard.

This second substrate 31 also includes a conductive through-hole via 26 as well understood in the art. Such a conductive through-hole via 26 comprises an electrically conductive path (such as a small copper rod or a hole having at least portions of the wall of the hole having a conductive surface disposed thereon) through the second substrate 31, with the conductive through-hole via 26 being positioned so as to register with and contact the off-board pad 21 provided on the first substrate 20. So configured, when the first and second substrates 20 and 31 are disposed in contact with one another, the conductive through-hole via 26 provides a point of electrical access on the second substrate 31 to the electric circuit on the first substrate 20.

The second substrate 31, in this embodiment, also includes an alignment pin 27 comprising a small plastic pin that extends outwardly of the second substrate 31. Again, as will be shown below, this alignment pin 27 serves to facilitate appropriate alignment of two such apparatus 10 when combined with one another during game play. In this embodiment, the second substrate 31 also includes holes 23B that correspond to the game position marker station holes 23A as are provided in the first substrate 20 as described above. And lastly, in this embodiment, the second substrate 31 includes two holes 22B and 25A to receive light emitting diodes (with one hole 25A serving to receive the light emitting diode 17 as disposed on the first substrate 20 and the remaining hole 22B serving to receive the light emitting diode of a second game apparatus 10 when the latter is combined during game play with this apparatus 10.

A third substrate 32 comprised again of any appropriate non-conducting material and preferably of a suitable paper product and/or a thin plastic sheet or laminate has an access channel 28 disposed therethrough. This access channel 28 has a width that is, at least in part, narrower than the game position marker 11. So configured, while access to the game position marker 11 can be had via the access channel 28, the game position marker 11 will nevertheless be substantially encapsulated and retained within the game position marker channel 12. In a preferred embodiment, the various pathway segments that comprise the access channel 28 will extend beyond their respective intersections such that a small pathway extension will be provided beyond such points of intersection. So configured, a small tool, such as, for example, the end of a paper clip, can be inserted through such small pathway extensions to permit desired access to the game position marker 11 when the game position marker 11 is positioned at a segment intersection that coincides with a game position marker station.

The opposing side of the third substrate 32 has electrodes 15 and inter-coupling conductors 16 as described earlier with respect to FIG. 1. Such electrodes 15 and conductors 16 (including a pad that will register with and electrically couple to the conductive through-hole via 26 of the second substrate 31) can be formed through the same processes as described above with respect to the first substrate 20 and essentially comprise a mirror image of the electrodes 13 and conductor 14 as formed on the first substrate 20 to thereby ensure that the electrodes 15 on the third substrate 32 are disposed substantially opposite to the corresponding electrodes 13 on the first substrate. Given this similarly of appearance and formation, for the sake of simplicity and brevity a view of the underside of the third substrate 32 is neither needed nor provided.

The third substrate 32 also includes membranes 29 that serve to occlude the holes 23A and 23B as provided in the first and second substrates 20 and 31, respectively. This membrane is preferably relatively thin, such that the membrane will flex when a force is exerted by, for example, a game player's finger as disposed through the game position marker station holes 23A and 23B. When two such apparatus 10 are aligned and combined back to back as described below, pressure as imposed against such a membrane of a first game apparatus will be also exerted upon the corresponding game position marker locations of a second game apparatus to thereby permit completion of the earlier described electrical circuit when the selection game position marker location in fact includes the game position marker 11.

In this embodiment, the third substrate 32 further includes a hole 24B disposed therethrough to receive an alignment pin of another game apparatus 10 and two holes 25B and 22C disposed therethrough to receive a light emitting diode in the same manner as the second substrate 31. The third substrate 32 also includes a hole 30 disposed therethrough that receives the alignment pin 27 of the second substrate 31.

With reference to FIG. 4, the third substrate 32 can also include visually exposed game position indicators 41 to indicate candidate game positions along the game position marker channel 28 (only one such candidate game position is depicted with such an indicator 41 in this figure for the sake of clarity and simplicity). FIG. 4 also illustrates that a small tool, such as a paperclip (not shown) can be inserted into the access channel 28 and then used to urge the game position marker 11 to a new station that corresponds to the location of the earlier described electrode pairs.

So configured, when a game position marker 11 is purposely disposed by a first game player between an electrode 13 and an opposing electrode 15, and the two electrodes are then brought into simultaneous contact with the game position marker 11, an electric circuit will be completed to thereby effect energization of an appropriate alert mechanism (which may be visual, auditory, and/or some other sensory stimulus). In the embodiment described, the game position marker 11 comprises a battery. If desired, an energy source can be provided in other ways. For example, a small battery of the same or similar type can be embedded within the second substrate. When so configured, the game position marker 11 can be comprised instead of at least some inactive but electrically conductive material.

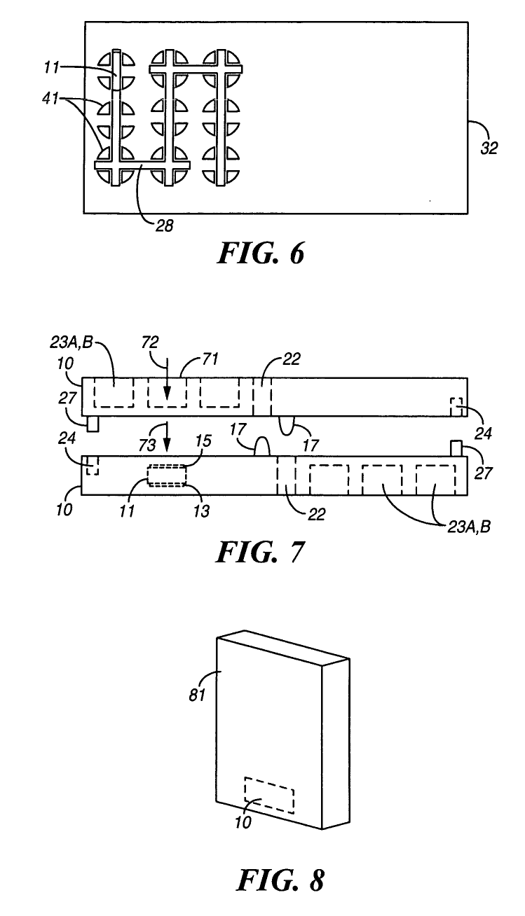

In the illustrative and explanatory embodiments presented above, only three game position marker stations are depicted. In general, a larger number of such candidate stations are likely to be preferred to provide an increased game playing challenge. As the number of candidate stations increases, it is likely that a more complicated and/or dense electrode pattern will result. With reference to FIG. 5, one way to permit convenient game position marker access to each such candidate station is to configure the game position marker channel 12 as a substantially serpentine shape. When so configured, and referring now to FIG. 6, the access channel 28 can have a likewise serpentine shape to substantially track and conform to the game position marker channel 12. An S-shaped pattern as depicted, for example, can readily accommodate nine game position marker stations (with each such station being marked, in this illustrative embodiment, by a corresponding visually exposed game position indicator 41 as described earlier.

As suggested above, two such game apparatus 10 can be readily combined to permit the playing of a guessing game. Presuming two players, each player can move the game position marker 11 in their respective game apparatus 10 to a desired game position marker station of their choosing without disclosing their selection to the opposing player. The players can then place their respective game apparatus 10 back-to-back with one another as illustrated in FIG. 7. In particular, in addition to aligning the general perimeters of each apparatus 10 with one another, the alignment pin 27 of each apparatus 10 is aligned with and inserted into the corresponding hole 24 on the opposing apparatus. In a somewhat similar fashion, the light emitting diode 17 for each apparatus 10 is disposed within the corresponding hole 22 on the opposing apparatus.

So configured, the finger-receiving holes 23A,B on each apparatus 10 are aligned with the electrodes 13 and 15 that characterize the game position marker stations on the opposing apparatus 10. When a player selects a particular finger-receiving hole 72 that coincides with the location of the corresponding game position marker 11, the force 72 exerted by the player's finger is transmitted 73 through the occluding membrane 29 described above with respect to FIG. 2 and causes the two electrodes 13 and 15 for that station to simultaneously contact the game position marker 11. As described above, such contact completes an electric circuit that in turn causes, for example, the light emitting diode 17 for the corresponding game apparatus 10 to become illuminated. It should be noted that, in such a preferred embodiment, a user force as exerted via a first game apparatus (i.e., a first player's game board) is transferred mechanically to a second game apparatus (i.e., a second player's game board) to effect game play. This unique user interface contributes in part to a sense of an integrated game platform even though two separate boards in fact comprise the platform.

Each player can gauge and determine their relative success by maintaining a count, for example, of the number of guesses that each requires to correctly identify a present location of the opposing player's game position marker 11. Upon concluding a round of game play, the two game apparatus boards 10 are readily separated to permit the players to move their game position markers 11 to a new station. The apparatus boards 10 can then again be mated and another round of game play conducted. Such mechanical programming permits extended and potentially engaging game play as versus a one-use-only fixed position game platform.

Such an hermaphroditic guessing game apparatus 10 can be fabricated at relatively low cost and with materials that are safe for disposition in proximity to edible products. For example, and referring now to FIG. 8, such an apparatus 10 can be economically, easily, and safely included as a promotional item with a food product such as a package 81 of an edible commodity such as breakfast cereal. The apparatus 10 can be included inside the package 81 or can be disposed on an exterior portion of the package 81. If desired, and taking into account that the above embodiments can be realized using paper and paper board products (with or without the use of plastic sheeting and/or laminate material for one or more of the substrates), the package 81 itself can serve as an integral part of one of more of the substrates of the apparatus 10, thereby potentially achieving even greater economic savings. Such an apparatus can also serve to support a variety of other promotional activities, including but not limited to direct mail offerings, a promotional event hand-out, and a so-called near-pack offering as provided at or near the point of the consumer purchasing decision in a retail establishment.

The length and width of the apparatus 10 can vary as needed to suit the needs and/or constraints of a given application. Similarly, the thickness of the various substrates can be varied as appropriate to the needs of a given choice of materials and intended user context.

Those skilled in the art will recognize that a wide variety of modifications, alterations, and combinations can be made with respect to the above-described embodiments without departing from the spirit and scope of the invention, and that such modifications, alterations, and combinations are to be viewed as being within the ambit of the inventive concept. For example, for purposes of illustration three substrates have been depicted and described. In fact, each such “substrate” can itself be comprised of a plurality of layers and substrates as selected to suit the needs of a given setting. As another example, instead of providing a game position marker that moves in a channel between opposing electrodes, the game position marker can instead move in a channel in close disposition to opposing electrodes that are ordinarily separated from one another by some biasing force. For example, membrane keyboard technology can be used to fashion such an approach, where the game position marker (which can be comprised of an insulating material if so desired in such an embodiment) is moved as desired to position the marker above (or below) the keys of the membrane keyboard.

1. An apparatus comprising:
a game position marker comprised, at least in part, of electrically conductive material;
a first substrate comprising at least a part of a guessing game, the first substrate having a game position marker channel formed therein, wherein the game position marker channel has a width at least large enough to accommodate the game position marker;
a second substrate disposed proximal to the first substrate and having an access channel disposed therethrough, the access channel having a width that is, at least in part, narrower than the game position marker, wherein the game position marker is retained within the game position marker channel, at least in part, by the second substrate and wherein a narrow object can be inserted through the access channel and used to move the game position marker to different game positions within the game position marker channel.

2. The apparatus of claim 1 wherein the game position marker is fully comprised of electrically conductive material.

3. The apparatus of claim 1 wherein the game position marker is substantially disc-shaped.

4. The apparatus of claim 1 wherein the game position marker comprises a battery.

5. The apparatus of claim 1 wherein the first substrate is at least partially comprised of paperboard.

6. The apparatus of claim 1 wherein at least a portion of the game position marker channel has a substantially serpentine shape.

7. The apparatus of claim 1 wherein the first substrate further includes a plurality of holes disposed fully therethrough.

8. The apparatus of claim 7 wherein at least some of the plurality of holes correspond to a game opponent's candidate game positions.

9. The apparatus of claim 8 wherein the second substrate further includes an occluding portion that at least substantially covers at least some of the plurality of holes.

10. The apparatus of claim 1 wherein the first substrate further includes:
a least one registration pin extending outwardly therefrom; and
at least one registration hole formed therein;
such that the apparatus can be placed into properly alignment with another object through use of the registration pin and registration hole.

11. The apparatus of claim 10 wherein the object comprises an object that is substantially mechanically and electrically similar to the apparatus, such that the registration pin of the apparatus is placed within a registration hole of the object and the registration hole of the apparatus receives a registration pin of the object when the apparatus and the object are properly aligned with one another.

12. The apparatus of claim 1 and further comprising visually exposed game position indicators disposed to indicate candidate game positions along the game position marker channel.

13. The apparatus of claim 12 wherein the visually exposed game position indicators are disposed on the second substrate proximal the access channel.

14. The apparatus of claim 12 wherein there are at least nine visually exposed game position indicators.

15. The apparatus of claim 1 wherein the game position marker channel includes conductive material disposed proximal thereto.

16. The apparatus of claim 15 wherein the conductive material includes electrodes disposed at candidate game positions along the game position marker channel.

17. The apparatus of claim 16 wherein the conductive material further comprises conductive paths that intercouple at least some of the electrodes.

18. The apparatus of claim 15 wherein the first substrate includes at least one conductive path disposed at least partially therethrough.

19. The apparatus of claim 18 wherein the at least one conductive path operably couples to a conductive path that is disposed on the second substrate.

20. The apparatus of claim 19 wherein:
the game position marker channel has electrodes disposed at candidate game positions therealong; and
the second substrate has opposing electrodes disposed at candidate game positions along the access channel and substantially opposite the game position marker channel electrodes.

21. The apparatus of claim 20 and further comprising a conductive path that couples at least some of the electrodes to at least some of the opposing electrodes, such that when the game position marker is disposed between an electrode and an opposing electrode, and when the electrode and opposing electrode are simultaneously brought into conductive contact with the game position marker, an electric circuit is completed.

22. The apparatus of claim 21 wherein the electric circuit further includes an audio signal source, such that when the electric circuit is completed an audible sound is created.

23. The apparatus of claim 21 wherein the electric circuit further includes a light source, such that when the electric circuit is completed the light source illuminates.

24. The apparatus of claim 23 wherein the light source provides illumination outwardly from the second substrate.

25. The apparatus of claim 1 and further comprising a third substrate disposed on a side of the first substrate substantially opposite the second substrate.

26. The apparatus of claim 25 wherein the third substrate has images disposed thereon, at least some of which images correspond to a guessing game, which guessing game relates to a present position of the game position marker.

27. The apparatus of claim 26 wherein the third substrate further includes indicia that corresponds to candidate game positions for the game position marker.

28. An hermaphroditic guessing game apparatus to facilitate a game wherein opposing players attempt to guess a present location of a game position marker, comprising:
a first player's game board having a game position marker movably encapsulated therein, and further having:
on a first side thereof, a first plurality of candidate game position indicators and access to the encapsulated game position marker, such that the first player can selectively move the game position marker to a selected game position as denoted by one of the candidate game position indicators;
on another side thereof, a second plurality of candidate game position indicators;
such that when a first and second one of the game boards are properly disposed in proximity to one another, the first plurality of candidate game position indicators for the first game board are substantially aligned with the second plurality of candidate game position indicators for the second game board, and the second plurality of candidate game position indicators for the first game board are substantially aligned with the first plurality of candidate game position indicators for the second game board.

29. The hermaphroditic guessing game apparatus of claim 28 wherein the game position marker is encapsulated within a channel formed within the game board.

30. The hermaphroditic guessing game apparatus of claim 29 wherein the game position marker comprises a battery.

31. The hermaphroditic guessing game apparatus of claim 29 wherein the game position marker comprises, at least in part, electrically conductive material.

32. The hermaphroditic guessing game apparatus of claim 28 wherein the game board further includes electrically conductive paths.

33. The hermaphroditic guessing game apparatus of claim 32 wherein the game board further includes electrodes disposed proximal to each of the first plurality of candidate game position indicators, wherein at least some of the electrodes are electrically coupled to one another by the electrically conductive paths.

34. The hermaphroditic guessing game apparatus of claim 33 and further comprising a light source operably coupled to at least some of the electrodes.

35. The hermaphroditic guessing game apparatus of claim 33 and further comprising an audio source operably coupled to at least some of the electrodes.

36. The hermaphroditic guessing game apparatus of claim 28 wherein the game board is included as a promotion item within packaging for a commodity.

37. The hermaphroditic guessing game apparatus of claim 36 wherein the commodity comprises an edible commodity.

38. The hermaphroditic guessing game apparatus of claim 28 wherein the game board is disposed as a promotion item on an exterior portion of packaging for a commodity.

39. The hermaphroditic guessing game apparatus of claim 38 wherein the commodity comprises an edible commodity.

40. The hermaphroditic guessing game apparatus of claim 38 wherein the game board comprises an integral part of the packaging.

41. A method comprising:
providing a consumer commodity;
providing packaging for the consumer commodity;
providing a promotional item comprising guessing game apparatus comprising:
a game position marker comprised, at least in part, of electrically conductive material;
a first substrate comprising at least a part of a guessing game, the first substrate having a game position marker channel formed therein, wherein the game position marker channel has a width at least large enough to accommodate the game position marker;
a second substrate disposed proximal to the first substrate and having an access channel disposed therethrough, the access channel having a width that is, at least in part, narrower than the game position marker, wherein the game position marker is retained within the game position marker channel, at least in part, by the second substrate and wherein a narrow object can be inserted through the access channel and used to move the game position marker to different game positions within the game position marker channel.
